(19) United States
(12) Patent Application Publication
(10) Pub. No.: US 2019/0082525 A1
(43) Pub. Date: Mar. 14, 2019

(54) Device For Forming Metal Components

(71) Applicant: Siemens Aktiengesellschaft, Muenchen (DE)

(72) Inventors: Christian Buske, Bielefeld (DE); Artur Grishin, Steinhagen (DE); Alexander Knospe, Bad Münder (DE); Florian Eder, Erlangen (DE)

(73) Assignees: Siemens Aktiengesellschaft, Muenchen (DE); Plasmatreat GmbH, Steinhagen (DE)

(21) Appl. No.: 16/084,378

(22) PCT Filed: Mar. 13, 2017
(86) PCT No.: PCT/EP2017/055832

§ 371 Date: Sep. 12, 2018

(30) Foreign Application Priority Data
Mar. 17, 2016 (DE) 10 2016 204 449.4

(51) Int. Cl. H05H 1/24; C22F 1/06

(52) U.S. Cl. CPC H05H 1/2406; H05H 2001/2418; C22F 1/06

(57) ABSTRACT

Various embodiments include an apparatus for forming metallic components comprising: tools for forming the metallic component; and a plasma generation module for treating a surface of a tool for forming and/or of the metallic component to be formed by applying an atmospheric pressure plasma.

### CROSS-REFERENCE TO RELATED APPLICATIONS

This application is a U.S. National Stage Application of International Application No. PCT/EP2017/055832 filed March 13, 2017, which designates the United States of America, and claims priority to DE Application No. 10 2016 204 449.4 filed March 17, 2016, the contents of which are hereby incorporated by reference in their entirety.

### TECHNICAL FIELD

The present disclosure relates to forming metal components. Various embodiments may include an apparatus which can be used for forming metallic materials, e.g. for pressure forming, for example by areal rolling, tensile forming, for example by stretching, and/or tensile pressure forming, for example for deep drawing.

### BACKGROUND

In the forming of metals, in particular the forming of metal sheets, workpieces are produced by plastic deformation. For this purpose, a metal sheet is, for example on a pressing table, subjected to working by means of a tool, for example a pressing ram. In this process, the surfaces of the tool are treated with friction-reducing agents such as drawing and forming oils so as to avoid or at least reduce groove formation, cracks and pressure points on the metal to be formed and/or the tool by means of reduced friction. The use of the friction-reducing agents also reduces the heat of friction and deformation and the apparatus therefore operates with less consumption of energy.

The use of the known friction-reducing agents such as oils may result in carrying-over. The oils drip off from the component to be formed, are displaced on application of relatively high pressures and/or they are released into the surroundings as aerosol when applied by spraying. The oil is applied to the tools and/or to the component before forming, and after the forming process it is necessary to free tool and/or component from oil again in complicated procedures.

To avoid these process steps which are additionally required for forming, dry lubricants are also used, but these are more complicated to apply than the oils and generally also require cleaning subsequent to forming.

### SUMMARY

The teachings of the present disclosure may provide embodiments that overcome the disadvantages of the prior art, e.g., an apparatus for forming metallic components, by means of which reduced friction between tool and workpiece to be formed can be realized without the apparatus being contaminated by dry lubricants and/or oils. For example, some embodiments may include an apparatus for forming metallic components, which comprises tools for forming, wherein a plasma generation module by means of which at least one surface of a tool for forming and/or of the metallic component to be formed can be treated and/or coated using an atmospheric pressure plasma is provided.

In some embodiments, the plasma generation module has a precursor feed facility which is configured for guiding a precursor into the region of a plasma generated by means of the plasma generation module.

In some embodiments, the plasma generation module has a plasma nozzle which is configured for generating an atmospheric plasma beam.

In some embodiments, the plasma generation module has an electrode and a dielectric surrounding the electrode, with the electrode being configured for being supplied with a high-frequency voltage by a voltage source.

In some embodiments, the plasma generation module comprises an electrode and a process gas feed conduit, with the electrode being configured for being supplied with a high-frequency voltage by a voltage source and the process gas feed conduit being configured for guiding a process gas stream into the region of the electrode.

In some embodiments, the precursor feed facility is connected to at least one precursor stock vessel so that an organic or metal-organic precursor can be fed into the plasma generation module.

In some embodiments, the precursor comprises a hydrocarbon compound which has at least one carbon-carbon multiple bond.

In some embodiments, the precursor comprises a hydrocarbon compound which is in gaseous form at room temperature.

In some embodiments, the precursor comprises an organosilicon compound.

As another example, some embodiments include a process for forming a metallic component, wherein at least one prescribed surface of the apparatus for forming and/or of the component to be formed is coated or freed of the coating by treatment with atmospheric pressure plasma before and/or after forming of the metallic component.

In some embodiments, the treatment with atmospheric pressure plasma is carried out without precursor and coating by means of atmospheric pressure plasma is carried out using a carbon-containing precursor.

### DETAILED DESCRIPTION

The teachings of the present disclosure may include an apparatus for forming metallic components, which comprises tools for forming such as a pressing table and a pressing ram, wherein a plasma generation module by means of which at least one surface of a tool for forming and/or of the metallic component to be formed can be treated and/or coated using an atmospheric pressure plasma is provided. It has been found that a plasma generation module, in particular one which operates under atmospheric pressure and does not necessarily require a closed pressure chamber for generation of the plasma, achieves uniform coating of all surfaces which are relevant in respect of frictional damage in the forming process for metallic components, which coating reduces the friction of the workpiece against the tool so that groove and/or crack formation and also pressure point formation on the tool and also on the metallic component to be formed are reduced. In addition, the coating makes a contribution to reducing the heat of deformation.

For the present disclosure, a plasma generation module is a single-part or multipart module by means of which a plasma can be generated within the apparatus for forming metallic components. This can be, for example, a plasma nozzle, an electrode configuration having at least one or more electrodes and/or another plasma source. The electrode can also be part of the apparatus for forming metallic components and/or part of one or more of the tools. The plasma generation module or a part of the plasma generation module can be arranged movably or in a fixed position within the apparatus for forming metallic components.

In some embodiments, the electrode can also be, for example, a consumable electrode which when being consumed provides a precursor for coating/treatment of a tool of an apparatus for forming metallic components and/or the metallic components.

In some embodiments, the plasma generation module generates a spatially limited plasma. Compared to a plasma which extends essentially over the entire interior surface of a plasma pressure chamber, the region to be treated and/or to be coated is adjustable. In addition, in the case of a coating, the activation of the precursor can occur directly in the region of the coating.

In some embodiments, the plasma generation module comprises a plasma nozzle by means of which an atmospheric plasma beam can be generated. In some embodiments, the plasma nozzle generates an atmospheric plasma beam.

In some embodiments, the plasma nozzle comprises a precursor feed facility through which a prescribed precursor can be applied with or without process gas and/or ambient air as plasma to the surface of the tool and/or of the metallic component or parts thereof. Fixedly anchored or mobile integration of the plasma generation module into the apparatus for forming metallic components allows precise metering of the precursor in the direct vicinity of the location of coating and thus to be able to set the desired thickness of the coating.

In some embodiments, the atmospheric plasma beam is generated by means of an electric discharge in a working gas, e.g. in the plasma nozzle. The atmospheric plasma beam may be generated by an arc discharge produced using a high-frequency effective voltage, which can also be considered to be an arc-like discharge, in a working gas. A high-frequency high voltage is typically a voltage of from 1 to 100 kV, in particular from 1 to 50 kV, or from 10 to 50 kV, at a frequency of from 1 to 150 kHz, in particular from 10 to 80 kHz, from 10 to 65 kHz, or from 10 to 50 kHz. However, the atmospheric pressure plasma coating can also be carried out at lower high-frequency voltages, i.e. at voltages in the region of 1 kV or below.

A plasma beam which firstly has a high reactivity and secondly has a comparatively low temperature is generated in this way. As a result of the high reactivity, an effective treatment of the surfaces or an effective activation of the precursor and thus effective and uniform coating or cleaning can be achieved. Due to the low temperature of the plasma beam, damage to the tools and the apparatus can also be avoided.

In some embodiments, the plasma nozzle comprises a nozzle opening from which a directed plasma beam exits during operation. The nozzle opening can be configured and arranged so that the direction of the plasma beam runs essentially parallel to the longitudinal axis of the plasma nozzle or to the longitudinal extension direction of the surface to be treated or to be coated or to be treated. In this case, a bounce body such as a bounce plate, by means of which the plasma beam can be deflected in the direction of the surface to be coated or to be treated, may be arranged in front of the nozzle opening.

In some embodiments, a nozzle opening of the plasma nozzle is configured and arranged so that the plasma beam during operation exits from the nozzle opening obliquely to the longitudinal axis of the plasma nozzle or obliquely to the longitudinal extension direction of the surface to be treated or to be coated. In this way, the plasma beam is directed against the surface to be treated or to be coated in such a way that the plasma beam can impinge directly on the surface and/or a precursor can be supplied to the surface by means of the plasma beam.

In some embodiments, a dielectric barrier discharge is generated between an electrode of the plasma generation module and a counterelectrode. In some embodiments, the plasma generation module has an electrode and a dielectric surrounding the electrode, with the electrode being configured for being supplied with a high-frequency voltage by a voltage source.

In the present disclosure, a dielectric barrier discharge means a form of a discharge between an electrode and a counterelectrode in the case of which the electrode and the counterelectrode are electrically insulated by a dielectric arranged in between, so that no direct discharges between the electrode and the counterelectrode are possible. In the apparatus, the dielectric is therefore arranged between the electrode and the respective counterelectrode during operation. The dielectric can be, for example, a ceramic dielectric. The power input into the plasma occurs essentially capacitatively in the dielectric barrier discharge.

In the surface treatment, in particular in the surface coating operation, the part of the apparatus for forming metallic components which is to be treated or to be coated or the metallic component itself can function as counterelectrode. For this purpose, the part of the apparatus or the component can be connected in particular to a fixed potential, for example to ground. In some embodiments, particularly in the case of surface treatment or surface coating of an electrically nonconductive tool of the apparatus for forming metallic components, a separate counterelectrode can be provided within or outside the apparatus for forming metallic components. Such a counterelectrode can, for example, be moved together with the plasma generation module for surface treatment or surface coating. The counterelectrode can also be configured as part of the plasma generation module.

In some embodiments, a high-frequency voltage is applied between an electrode of the plasma generation module and a counterelectrode in such a way that a direct discharge between the electrode and the counterelectrode occurs. In contrast to a dielectric barrier discharge, a direct discharge is a discharge in which the electrode and the counterelectrode are not electrically insulated relative to one another, so that direct discharges between the electrode and the counterelectrode are possible. The discharges between the electrode and the counterelectrode can be arc-like high-frequency discharges in which individual discharge filaments go over from the electrode to the counterelectrode or vice versa.

In some embodiments, a process gas stream flows into the region of the direct discharges between the electrode and the counterelectrode. In some embodiments, the plasma generation module comprises an electrode and a process gas feed conduit, with the electrode being configured so as to be supplied with a high-frequency voltage by a voltage source and the process gas feed conduit being configured for conducting a process gas stream, for example a process gas stream which also moves laterally, into the region of the electrode.

In the present disclosure, a moving process gas stream means that the process gas stream has a velocity component in the longitudinal extension direction or in the direction of movement of the plasma generation module and in addition a velocity component perpendicular thereto, so that the process gas stream also, for example, rotates and forms a type of vortex. In some embodiments, the high-frequency discharges are influenced by such a rotating process gas stream in such a way that more stable and more uniform operation is possible. In particular, more uniform distribution of the plasma or of the precursor over the surface to be treated or to be coated can be achieved in this way. To produce a rotating process gas stream, the process gas feed conduit can have, for example, a ring of holes which are set obliquely in the circumferential direction and by means of which an inflowing process gas stream is made into a rotating process gas stream.

In some embodiments, the plasma generation module or at least part thereof can be moved by means of magnetic force so that it moves through the apparatus for forming metallic components or part thereof or around the metallic component to be formed. In some embodiments, the transport mechanism is configured for moving the plasma generation module or at least part thereof through the apparatus by means of magnetic force.

In some embodiments, the feed conduit for the precursor is arranged movably or in a fixed position in the apparatus for forming metallic components, and may comprise a feed conduit for a carrier gas. This makes continuous and uniform or meterable introduction of the precursor gas possible, so that uniform coating of the desired surfaces can be achieved. The precursor can be introduced in gaseous or liquid form through a precursor feed conduit which is arranged outside the apparatus but is connected to the plasma generation module within the apparatus. In some embodiments, the precursor can be conveyed by means of such a precursor feed conduit, in particular a precursor lance, right into the region of the plasma. Furthermore, such a precursor feed conduit allows the precursor to be fed into the plasma at a defined place and, for example, spatial separation of the center of the discharges and the activation zone for the precursor thus to be achieved.

In some embodiments, the apparatus has a precursor feed conduit configured for conveying a precursor into the region of a plasma generated by means of the plasma generation module. In some embodiments, there is a precursor feed conduit for introducing a precursor by means of a carrier gas into the apparatus for forming metallic components. In some embodiments, a precursor feed conduit, for example a precursor lance, is at least partly integrated into the plasma generation module and/or connected to the latter and by means of which a precursor can be guided into the region of the plasma which can be generated by means of the plasma generation module. As indicated above, such a precursor feed conduit allows the precursor to be fed into the plasma at a defined place and, for example, spatial separation of the center of the discharges and the activation zone for the precursor thus to be achieved.

In some embodiments, the metallic component is provided with a friction-reducing coating, in particular an organic protective layer in the nanometer range, i.e. having a layer thickness of less than 1000 nm or less than 1 μm, by the treatment with plasma, in particular with atmospheric pressure plasma, before forming. A coating having a thickness in the range from 5 nm to 1000 nm, for example from 50 nm to 500 nm, from 100 nm to 400 nm, or from 200 nm to 300 nm, may result.

In some embodiments, the plasma generation module is, after forming of the metallic component is complete, used for removing the organic protective layer on the component and/or on parts thereof and also on the tools of the apparatus for forming metallic components and also on parts thereof. The plasma generated through the nozzle may comprise a plasma discharge obtained by means of a corona discharge, by means of a dielectric barrier discharge or by means of an arc-like discharge.

In the present disclosure, a precursor is a substance which is suitable for forming a coating on a tool and/or a metallic component. For example, the precursor can be a chemical compound which gives the desired coating material by polymerization or another chemical reaction. As a result of the interaction with the plasma, the precursor can, for example, be fragmented and/or partially ionized so that its reactivity is increased. Furthermore, the plasma can also supply a necessary activation energy which is required for a chemical reaction of the precursor, in particular for a polymerization. For example, a precursor can be an organic compound, in particular a hydrocarbon-containing compound, or a metal-organic compound. For example, a precursor can simply be petroleum spirit and/or diesel oil. Aliphatic and/or cyclic hydrocarbons, for example, can be used as precursors. The precursor can, for example, be present in liquid or gaseous form and be used with or without process gas.

Examples of precursors provided for the organic protective coating may be provided here on a tool of an apparatus for forming metallic components or a part thereof and/or of a metallic component to be formed are metal-organic compounds such as alkyl-functional silanes, e.g. HMDSO: hexamethyldisiloxane, TEOS, VTMS: vinyltrimethylsilane, OMCTS: octamethyltetracyclosiloxane; hydrocarbons, in particular hydrocarbons having at least one carbon-carbon multiple bond; short-chain hydrocarbons such as methane; unsaturated hydrocarbons such as acetylene, ethene; short-chain hydrocarbons which are present in gaseous form at room temperature, and also any cycloaromatics, cycloaliphatics, halogen- or pseudohalogen-substituted and/or cyclic hydrocarbons, for example fluorine-containing hydrocarbons, e.g. octafluorocyclobutane, octafluorocyclopentane, and any mixtures thereof.

In some embodiments, the metallic component is freed of the friction-reducing protective coating in the nanometer range by treatment with atmospheric pressure plasma without precursor after forming. Here, for example, the nozzle of the plasma generation module is operated using air as process gas and/or at moderate or high power. A precursor is not necessary in this cleaning phase. The highly reactive plasma leads, under atmospheric conditions, to oxidation of the organic protective layer and removes the latter. Further wet cleaning of the surface is no longer necessary. For example, it is sufficient for only one tool, for example the roller or the pressing ram, to be coated in the apparatus for forming metallic components. At low degrees of deformation, no cleaning of the profile, for example, is provided and the tools can be used a number of times in forming processes after being coated once with an organic protective coating.

In some embodiments, a plasma generation module generates an inductively or capacitatively coupled plasma within the apparatus for forming metallic components and a precursor is optionally brought to interact with the plasma in such a way that a coating is formed on the intended surfaces of metallic components within the apparatus for forming and/or on the surface of the metallic component to be formed. For this purpose, the surface concerned can, for example, be arranged within a coil or between two capacitor plates, with a high-frequency voltage being applied to the coil or the capacitor. The surface may in this case be arranged within a subatmospheric pressure environment in order to assist the formation of the inductive or capacitative plasma. In this process, the frequency of the high-frequency voltage may be in the range from 10 to 75 kHz, in particular from 15 to 55 kHz, in particular from 25 to 45 kHz.

The apparatus and/or the process embodiments described herein may be used in roller profiling or else in all other bending forming processes in which lubricant oils and forming oils or dry lubricants are used at present. The system may provide polished, decorative surfaces. Even the application of a very thin organic protective layer may prevent the formation of scratches and can thus replace processes in which the surfaces are protected in a complicated manner by application of a film before the forming process. Particularly in the automobile industry, significant cost advantages are obtained here, so that the use of, for example, stainless steel profiles becomes conceivable in the middle to lower price segment, too. The invention can be used not only in bending forming but likewise in pressure forming (areal rolling), tensile forming (stretching) and tensile pressure forming (deep drawing of hollow bodies).

Some embodiments include an apparatus which can be used for the forming of metallic materials. For example, some embodiments include an apparatus for bending forming such as pressure forming, for example by areal rolling, tensile forming, for example by stretching, and/or tensile pressure forming, for example for deep drawing. To reduce the damage and energy losses arising as a result of frictional losses and frictional damage during the forming process, a plasma generation module by means of which selected surfaces of the tools of the apparatus and/or of the metallic components to be formed can be coated with a coating in the nanometer range, in some cases before forming, and can be treated, i.e., for example, freed of the organic protective layer again, after forming be provided in the apparatus.

What is claimed is:

1. An apparatus for forming metallic components, the apparatus comprising:
tools for forming the metallic components;
a plasma generation module for treating a surface of a tool for forming and/or of the metallic component to be formed by applying an atmospheric pressure plasma.

2. The apparatus as claimed in claim 1, further comprising a precursor feed facility for delivering a precursor into a region of the atmospheric pressure plasma generated by the plasma generation module.

3. The apparatus as claimed in claim 1, further comprising a plasma nozzle for generating an atmospheric plasma beam in the plasma generation module.

4. The apparatus as claimed in claim 1, further comprising:
an electrode; and
a dielectric surrounding the electrode.

5. The apparatus as claimed in claim 1, further comprising:
an electrode; and
a process gas feed conduit for guiding a process gas stream into an effective region of the electrode.

6. The apparatus as claimed in claim 2, wherein the precursor feed facility is connected to a precursor stock vessel feeding an organic or metal-organic precursor into the plasma generation module.

7. The apparatus as claimed in claim 2, wherein the precursor comprises a hydrocarbon compound with a carbon-carbon multiple bond.

8. The apparatus as claimed in claim 2, wherein the precursor comprises a hydrocarbon compound in gaseous form at room temperature.

9. The apparatus as claimed in claim 2, wherein the precursor comprises an organosilicon compound.

10. A method for forming a metallic component, the method comprising treating a surface of an apparatus for forming or a surface of the component to be formed by subjecting the surface to an atmospheric pressure plasma.

11. The process as claimed in claim 10, wherein treating the surface with atmospheric pressure plasma includes treatment without a precursor; and
further comprising coating with the atmospheric pressure plasma in the presence of a carbon-containing precursor.
